(19) United States
(12) Patent Application Publication
(10) Pub. No.: US 2009/0222279 A1
(43) Pub. Date: Sep. 3, 2009

(54) Rate quote generation for optimization of travel agency profitability

(75) Inventor: Tim B. Reiz, Doral, FL (US)

Correspondence Address: Gard and Kaslow LLP, One 1st Street, Suite 9, Los Altos, CA, 94022, US

(73) Assignee: Farelogix Inc.

(21) Appl. No.: 12/072,928

(22) Filed: Feb. 29, 2008

(51) Int. Cl. G06Q 99/00

(52) U.S. Cl. 705/1

(57) ABSTRACT

In order for a travel agent to find travel services for clients and maintain profitability (or other advantages) for a travel agency, systems and methods for automatically generating rate quotes for travel services are provided. The travel agent provides the client's requirements for travel within a system that searches fare sources for available fares of travel services that meets the client's requirements. The system calculates rate quotes by applying a mark-up to the available fares from the search and then determines if the rates quotes are profitable based on agency profitability rules. If a rate quote is determined to be unprofitable (e.g., the marked-up fare is below a threshold of profitability), then the rate quote may be removed. The remaining rate quotes are sorted and provided to the travel agent. The travel agent can then offer travel services to the client at the marked-up fare rate quote.

### BACKGROUND

1. Field of the invention

The invention is in the field of travel services and more specifically in the field of searching for and pricing travel services.

2. Related Art

Clients often use travel agencies to find and purchase travel services such as airline flights, hotel accommodations, and car rentals. Traditionally, a client provides the necessary travel information to a travel agent who inputs the data into a system which searches another system such as a global distributed system (GDS) to find an available travel service (e.g., an airline flight) that fits the traveler's requirements and retrieve the appropriate fare. Typically, the fare undergoes a mark-up by the agency which is then offered as a quote to the client for the travel services.

Unfortunately, the quoted marked-up fare may not be profitable to the agency or take into account the latest incentives which are offered to the agency by, for example, the provider of the travel services. As a result, possible revenue or other potential business advantage may be lost.

Based on the search for travel services, a travel agent typically receives a display of marked-up fares for travel services and selects one or more of the marked-up fares to offer to the client. However, some of the marked-up fares may be more profitable to the agency than others. The travel agent is generally unaware of the profitability details, and, as a result, often fails to offer the more profitable marked-up fares.

Further, different marked-up fares may trigger incentives such as commissions, overrides, or discounts. Generally, travel agents are expected to recall which marked-up offer such incentives but may not always do so. Even if the travel agent recalls which marked-up fares are associated with an incentive, the travel agent may still not offer the marked-up fare with the highest incentive.

Travel agents are also expected to recall which marked-up fare may contribute to sales volume objectives that qualify for incentives but, likewise, may fail to do so.

For all of these reasons and likely others, the profitability of a typical travel agency is negatively impacted. What is needed, therefore, is an improved way to ensure travel agents are offering profitable travel services to the clients of the travel agency.

### SUMMARY

Systems and methods for generating rate quotes for travel services are provided. In various embodiments, client travel requirements are received and one or more fare sources are searched to locate a plurality of available fares. The search is based, at least in part, on the client travel requirements. A plurality of rate quotes, based on the plurality of available fares, is calculated. Any rate quotes that are not profitable, based on agency profitability rules, are then removed. The remaining rate quotes are then sorted and provided.

The method may further comprise selecting one or more fare sources from a group of fare sources based on the client travel requirements and/or any client preferences. The fare sources may include a global distribution system (GDS), a web server, a service provider server, and a travel agency device with locally stored fare data.

When generating the plurality of rate quotes, a mark-up is calculated based on agency profitability rules. The mark-up is added to an available fare to generate a rate quote. If, the rate quote (the available fare after adding the mark-up) is above a published fare, then the rate quote is removed.

An exemplary system for generating rate quotes for travel services is also provided. The system comprises a search module, a rate quote module, a filter module, a sort module, and a communication interface module.

The search module is configured to search one or more fare sources for a plurality of available fares based on client travel requirements. The rate quote module is configured to generate a plurality of rate quotes based on the plurality of available fares and remove a rate quote, from the plurality of rate quotes, based on agency profitability rules. The sort module is configured to sort the remaining plurality of rate quotes. The communication interface module is configured to receive the client travel requirements and provide the sorted plurality of rate quotes.

Further, an exemplary computer readable storage medium is also provided having embodied thereon executable computing instructions for performing a method for generating rate quotes for travel services. The method includes receiving client travel requirements, searching one or more fare sources for a plurality of available fares based on the client travel requirements, generating a plurality of rate quotes based on the plurality of available fares, removing a rate quote from the plurality of rate quotes that is not profitable based on agency profitability rules, sorting the plurality of rate quotes, and providing the plurality of rate quotes.

Further, another exemplary method for generating rate quotes for travel services is provided. The method comprises receiving client travel requirements, querying one or more fare sources based on the client travel requirements, receiving a plurality of available fares from the one or more fare sources, calculating a plurality of rate quotes based on the plurality of available fares, identifying one or more rate quotes from the plurality of rate quotes that are profitable based on agency profitability rules, sorting the plurality of identified rate quotes, and providing the plurality of rate quotes.

### BRIEF DESCRIPTION OF THE DRAWINGS

FIG. 1 is a block diagram of a travel agency device in operational context according to various embodiments.

FIG. 2 is a diagram of a travel agency device that generates rate quotes for travel services according to various embodiments.

FIG. 3 is a flow chart of a method for generating rate quotes for travel services according to various embodiments.

### DETAILED DESCRIPTION

Travel agents working for travel agencies help sell travel services to their clients (e.g., travelers) in order to generate revenue and increase profitability for the agency. In order to sell such travel services, the agent and/or agency must find available travel services that meet the client's needs. The client's needs may include specific requirements for travel service (e.g., date of travel, mode of travel, services desired, quality of service, etc.) as well as any personal and/or corporate client preferences (e.g., employees must travel business class or below when engaged in business travel, preferred carrier, etc.).

Once available travel services that meet the client's needs are found, the costs (i.e., fares) for the available travel services are reviewed to determine and/or apply a mark-up to them to thus create travel agency rate quotes for the travel services. Each rate quote is then reviewed to determine if it is sufficiently profitable and marketable. In determining profitability, the agency determines if sufficient money is made from the sale of the travel service to achieve the desired level of profitability. The agency may also take into account incentives, such as overrides or sales volume incentives, which the travel agency may receive as a result of selling the travel services. In determining marketability, the rate quote may be compared to comparable pricing for the travel services that are publicly available to clients. If the rate quote is above publicly available pricing for the travel services, the rate quote and related travel service are not offered to clients.

Rate quotes of travel services that are both profitable to the agency and marketable are then sorted and provided to the agent. The rate quotes may be sorted to promote profitability to the agency by ordering the rate quotes of travel services that are more profitable higher than rate quotes of travel services that are less profitable.

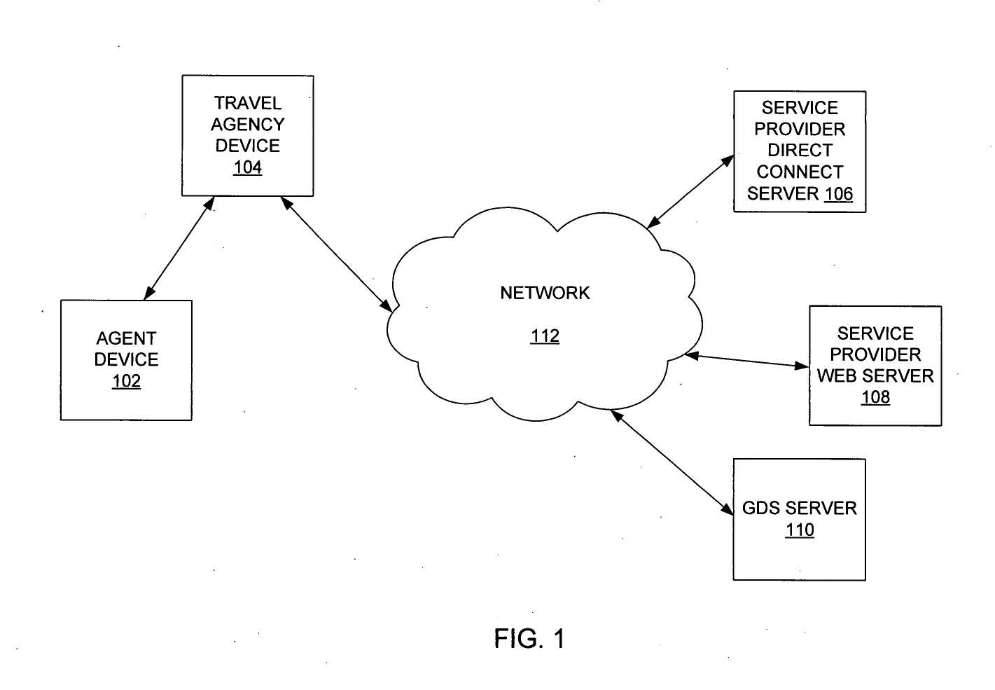

FIG. 1 is a block diagram of a travel agency device 104 in operational context according to various embodiments. An agent device 102 may communicate requirements for travel services to a travel agency device 104. Subsequently, the travel agency device 104 may communicate with a service provider direct connect server 106, a service provider web server 108, and a global distributed system (GDS) server 110 via a network 112 to find available fares for travel services that meet the client's requirements for travel. The agent device 102, the travel agency device 104, the service provider direct connect server 106, the service provider web server 108, and the global distributed system (GDS) server 110 are computing devices (e.g., computers) with at least a processor and memory.

The agent device 102 is configured to assist in the process of finding and purchasing travel services. A travel service is any service related to travel including, but not limited to, airline flights, cruises, or rail travel. Travel services may also include car rentals or overnight accommodations such as hotels, motels, and bed-and-breakfasts. Travel services may also include travel packages that combine services for travel such as, for example, an airline flight, hotel accommodation, and car rental reservation. Further, travel services may include the sale of insurance, travel guides, and timetables (e.g., schedules of events). Those skilled in the art will appreciate that travel services may cover many services and products related to travel.

The agent device 102 communicates with the travel agency device 104 to obtain available fares for the travel services. An available fare is the cost that the agency is charged for the travel services.

In one example, after communicating with a client, a travel agent inputs client travel requirements into the agent device 102 which then provides the client travel requirements to the travel agency device 104. Client travel requirements are those requirements necessary to identify travel services that satisfy the needs of the client (i.e., the client's requirements for travel). For example, the client travel requirements may include the point of origination and destination for travel, the mode of travel (e.g., airline flight), and the dates and time of travel. The client travel requirements may also include a class of accommodation (e.g., business class) and any other requirements (such as to only use one airline or to avoid another airline). Further, the client travel requirements may include a size of car for rental, insurance requirements for a rental car, number of beds in a room, location of hotel, quality of hotel (e.g., four stars), etc. Those skilled in the art and frequent travelers will appreciate that there may be any number of different kinds of client travel requirements.

The travel agency device 104 searches for available fares based on the client travel requirements received from the agent device 102 and generates rate quotes. A rate quote is the price for travel services that the client is to be charged. In some embodiments, the travel agency device 104 determines profitability of a travel service by comparing the rate quote (the price charged the client for the travel services) to the available fare (cost to the agency) for the travel service.

The travel agency device 104 may search one or more fare sources for available fares for travel services that meet the client travel requirements. A fare source includes any source (e.g., database) that is configured to provide available fares. Fare sources may include, but are not limited to, the service provider direct connect server 106, the service provider web server 108, and the GDS server 110, which are each discussed further herein.

For example, the client travel requirements may specify a round trip flight for a single passenger from Chicago to San Diego; the flight from Chicago to San Diego is to take place on Friday, Jul. 18, 2008, and the return flight is to take place Wednesday, Jul. 23, 2008. Further; the client travel requirements specify that the quality of service must be business class, the tickets must be refundable, and the airlines to be considered are American Airlines, United Airlines, and Delta Airlines. The available fares are those fares for travel services which include flights that meet the client travel requirements. In some instances, the available fares may be for travel services for multiple flights from United Airlines that leave Chicago at different times on Friday, Jul. 18, 2008. One or more of these flights may include layovers or be nonstop. Those skilled in the art will appreciate that there may be many available fares for travel services that meet the client travel requirements.

Once available fares for travel services that meet the client travel requirements are received from the fare sources, the travel agency device 104 generates the rate quote for each available fare. For example, the travel agency device 104 may determine the mark-up to apply to each available fare to generate the rate quote. Rate quotes that are undesirable (e.g., unprofitable) are removed. For example, if the available fare after mark-up (i.e., the rate quote) is significantly higher than what the client could purchase directly themselves (e.g., at a published fare price), then the rate quote is removed. The remaining rate quotes that have not been removed are then sorted and provided to the agent device 102.

The service provider direct connect server 106 is configured to provide available fares and information regarding travel services related to one or more service providers. A service provider is any provider of travel services. For example, a service provider may be, but is not limited to, an airline (e.g., United Airlines), a hotel chain (e.g., Hilton Hotels), a car rental agency (e.g., Hertz), a train service (e.g., Amtrak), or a vacation service (e.g., Pleasant Holidays).

In one example, the service provider direct connect server 106 receives a query based on client travel requirements from the travel agency device 104. In response, the service provider direct connect server 106 provides the available fares and/or information regarding available travel services based on the query (i.e., the provided available fares for travel services that meet the client travel requirements.)

In various embodiments, the service provider direct connect server 106 stores available fares and information related to available travel services. In one example, the service provider direct connect server 106 may contain a database or any data structure to store the available fares and information regarding travel services.

In some embodiments, the service provider direct connect server 106 downloads available fares and information regarding travel services to local storage on the travel agency device 104. In one example, an agency may have a business relationship with a service provider which provides discounted fares that are below fares generally offered by that service provider. When client travel requirements are received, the travel agency device 104 may search the locally stored available fares to find one or more fares that satisfy the client travel requirements.

The service provider web server 108 is a web server configured to provide available fares and information regarding travel services. An example of a service provider web server 108 is a web server hosted by American Airlines for providing fares and information regarding travel services associated with American Airlines flights and service. Other examples of a service provider web server 108 include, but are not limited to, Expedia, Travelocity, and Orbitz.

The GDS server 110 is a GDS configured to provide fares and information regarding travel services primarily to travel service professionals (e.g., travel agents). Examples of a GDS include, but are not limited to, Amadeus, SABRE, Galileo, and Worldspan. Further, the GDS server 110 may be a global distributed services new entrant (GNE). Examples of GNEs that provide services include, but are not limited to, Triton Distribution Systems, ITA Software, and G2 Switchworks.

The network 112 may comprise a public computer network such as the Internet, a private computer network such as a wired or wireless telecommunication network, a wide area network, a local area network, or any other types of network (or combination of networks) which is capable of providing communication between computing devices.

Although FIG. 1 depicts the agent device 102 coupled directly with the travel agency device 104, the agent device 102 may communicate with the travel agency device 104 via the network 112 or over another communications channel. In alternative configurations, this may operate as a client-server arrangement, as a web browser-web server arrangement or, alternatively, the agent device 102 may simply be a terminal in communication with the travel agency device 104.

In some embodiments, the agent device 102 is optional. For example, the travel agent or client may input client travel requirements directly into the travel agency device 104 without going through the agent device 102 and may receive rate quotes directly from travel agency device 104.

Although only one agent device 102, travel agency device 104, service provider direct connect server 106, service provider web server 108, and GDS server 110 are depicted in FIG. 1, there may be any number of agent devices 102, agency devices 104, service provider direct connect servers 106, service provider web servers 108, and GDS servers 110.

In some embodiments, the agent device 102 is operated by a travel professional such as an agent employed by a travel agency. The operation of the agent device 102, however, may not be limited to travel professionals. The client, without the use of an intermediary such as a travel agent, may themselves use the agent device 102 to find and purchase travel services. For example, the client's home computer may perform as the agent device 102 which communicates with the travel agency device 104 (e.g., via the Internet) to receive rate quotes.

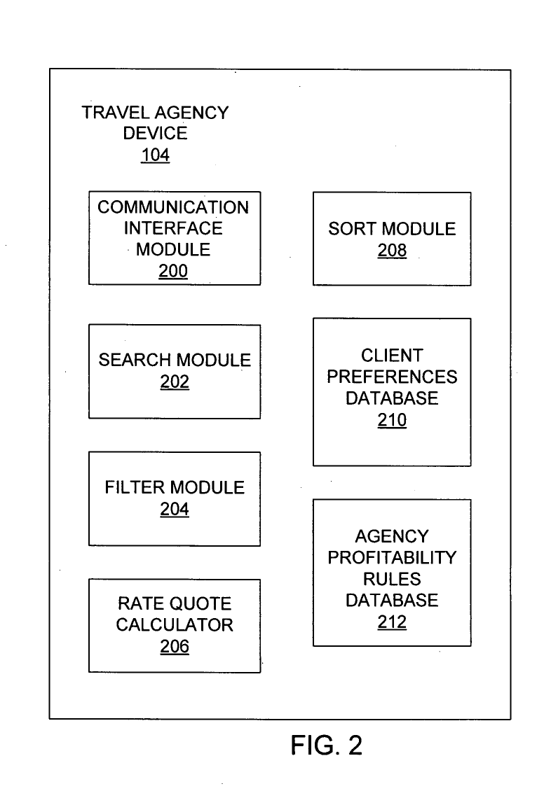

FIG. 2 is a diagram of a travel agency device 104 that generates rate quotes for travel services according to various embodiments. The travel agency device 104 comprises a communication interface module 200, a search module 202, a filter module 204, a rate quote generator 206, a sort module 208, a client preferences database 210, and an agency profitability rules database 212.

The communication interface module 200 is configured to receive client travel requirements. In various embodiments, the client travel requirements are provided by the agent device 102. For example, a travel agent may input the client travel requirements of a client into the agent device 102. The agent device 102 may then provide the client travel requirements to the travel agency device 104 via the communications interface module 200.

In some embodiments, the communications interface module 200 first provides a user interface (e.g., a graphical user interface) to the agent device 102. The agent at the agent device 102 then inputs the client travel requirements via the user interface. In one example, the travel agency device 104 is a web server and the communications interface module 200 provides one or more web pages to the agent device 102 that are configured to receive the client travel requirements input by the agent.

The search module 202 searches one or more fare sources based on the client travel requirements. In various embodiments, the search module 202 interacts differently with different fare sources. In one example, the search module 202 inputs data within a web page provided by the service provider web server 108 to generate an XML search query for the GDS server 110. In another example, the search module 202 may search locally stored available fares previously downloaded from the service provider direct connect server 106. Although available fares may be locally stored within the travel agency device 104, the search module 202 may search both the locally stored available fares and the service provider direct connect server 106 for the latest available fares.

The search module 202 may reformat the results of the searches from the fare sources (e.g., the available fares of travel services that meet the client travel requirements). In one example, the search module 202 takes data received in a variety of formats (e.g., available fares and information regarding travel services received from the service provider web server 108 and the GDS server 110) and organizes it into a tabular or structured list form.

In various embodiments, the search module 202 selects the fare sources to search based on the client travel requirements. In one example, the client travel requirements specify a flight on American Airlines. The search module 202 can select those fare sources from which available fares from American Airlines may be found (e.g., the service provider web server 108, the GDS server 110, but not the service provider direct connect server 106 if it does not provide American Airlines fares). In other embodiments, the search module 202 may search multiple fare sources and the filter module 204 (discussed further herein) may remove the available fares that do not meet all of the client travel requirements.

In addition to the client travel requirements, the search module 202 may also search for available fares based on client preferences. Client preferences are ongoing rules that a client may impose on travel services. In one example, a corporate client specifies client preferences regarding all employee travel. In one example, a client preference for a corporate client specifies that all airline.travel for employees of the client is to be on Delta Airlines when a flight with Delta Airlines is available. A client preference may also specify, for example, a requirement for a particular class of travel (e.g., business class or below), refundable/nonrefundable tickets, nonstop flights, a quality of hotel, insurance options for rental vehicles, class or provider of rental vehicles, etc. Those skilled in the art will appreciate that there may be any number of client preferences related to travel services.

Client preferences may also contain exceptions. In one example, the client preferences may specify that all employees, with the exception of specific officers, fly only on one of three airlines, while the specific officers (e.g., the CEO) may travel on any airline. In another example, a client preference specifies usage of a specific airline for all travel when traveling between Cities A, B, and C, otherwise any airline may be used for traveling between any other cities.

In various embodiments, the client preferences override the client travel requirements. For example, a client requests a first class accommodation from an agent who inputs the first class accommodation within the client travel requirements. However, client preferences specify that the employee may only travel business class or lower. As a result, the search module 202 applies client preferences over the client travel requirements. Here, the search module 202 searches for airline flights based on the other client travel requirements but based on the client preferences only searches for business class accommodations.

The filter module 204 removes any available fares for travel services found as a result of the search that do not satisfy the client travel requirements or client preferences. In some instances, the fare sources may not allow the search module 202 to perform searches utilizing all of the requirements specified by the client travel requirements and/or client preferences. As a result, not all of the available fares for travel services found as a result of the search may meet the client travel requirements or the client preferences. In those cases, the filter module 204 removes any travel services and/or related fares from the search results that do not meet the client travel requirements and/or the client preferences.

In one example, the search results for travel from city A to city B may include refundable and nonrefundable tickets because a fare source did not allow searching based on that requirement. However, client preferences specify that all tickets purchased must be refundable. As a result, the filter module 204 removes those available fares and information regarding travel services related to nonrefundable tickets.

The rate quote calculator 206 calculates rate quotes based on the results of the search (i.e., available fares for travel services that meet the client travel requirements and the client preferences) and removes any rate quote that is not determined to be profitable. As discussed previously, a rate quote is an available fare with a mark-up having been applied to it and is a price for travel services that may be offered to a client. The rate quote calculator 206 determines the mark-up and applies the mark-up to the available fares.

In various embodiments, the rate quote calculator 206 determines a mark-up based on agency profitability rules. Agency profitability rules are rules that govern an increase in an available fare (e.g., a mark-up) for travel services that may be sold to a client. Agency profitability rules may ensure that each rate quote to be offered to a client is profitable to the agency (e.g., the sale of the travel services at the rate quote provides a profit to the agency after taking into account any discounts and/or other incentives) and/or meet some other business goal (e.g., the sale would count towards a sales volume that must be obtained before a discount or other incentive is earned). In one example, agency profitability rules specify that all rate quotes will be available fares with a mark-up equal to the lowest published fare found. The lowest published fare is the lowest fare for a travel service that meets the client travel requirements and is available to the public directly. In another example, the agency profitability rules may require that all rate quotes for travel services to a client be an amount less than a published fare (e.g., $50 less than the published fare).

In various embodiments, the rate quote calculator 206, based on the agency profitability rules, determines that each available fare is to be marked-up a fixed amount but be below a published fare for travel services that meets the client travel requirements. If the rate quote (the available fare after mark-up) is above the published fare, the rate quote calculator 206 may remove the rate quote. For example, client travel requirements specify an airline flight on a certain date. The search module 202 finds an available fare for $195 for travel services that meet the client travel requirements. The search module 202 also finds a publicly available fare for $210 (i.e., a published fare) for travel services that meets the client travel requirements. The agency profitability rules, however, mandate a mark-up of $20 and that the marked-up fare rate quote must be less than the published fare. Since the rate quote ($215) (i.e., the marked up fare of $195+$20) is greater than the published fare ($210), the rate quote generator 206 removes the rate quote so that it is not offered to the client.

In other embodiments, based on the agency profitability rules, the rate quote calculator 206 can remove any rate quote for travel services that does not meet a threshold level of profitability and still be equal to or less than the published fare. In one example, the search module 202 may find an available fare for travel services and a published fare for travel services that meet the client travel requirements. The rate quote calculator 206 applies a fixed mark-up (such as a percentage increase) to the available fare to calculate a rate quote. If the mark-up is below a threshold level of profitability as specified by the agency profitability rules (e.g., at least a $20 difference between the available fare and the rate quote) and/or remain below the published fare, then the rate quote for travel services is removed.

Although the rate quote calculator is described as increasing an available fare by a fixed amount, those skilled in the art will appreciate that any published fare or any available fare may be increased or decreased by any amount as desired by an agency. In one example, the rate quote calculator 206 reduces the published fare by a fixed fee or a set percentage (e.g., 20%) and compares the rate quote to an available fare to select the highest one thus promoting agency profitability. In another example, the rate quote calculator 206 generates a rate quote that is a fixed amount or percentage above the cheapest available fare for travel services found in the search. As will be apparent to one of ordinary skill in the art, many different algorithms may be applied to determine the appropriate or possible mark-up.

The sort module 208 sorts the rate quotes. In various embodiments, the rate quotes may be sorted into groups by carrier or travel service provider (e.g., airline, hotel, or car rental service) and then the groups sorted. The sort module 208 may further sort the rate quotes within each group from lowest to highest.

The sort module 208 may sort the rate quotes based on the incentive to the agency. In one example, the sort module 208 may sort the rate quotes (or groups of rate quotes) in order of the rate quotes or groups that provides the highest incentive (e.g., override) or mark-up to the agency. In another example, the sort module 208 may sort the rate quotes to encourage transactions with certain airlines in order for an agency to meet a sales volume (e.g., quota) over a predetermined time in order to obtain further incentives from that airline (e.g., volume discounts or overrides).

In some embodiments, the sort module 208 may sort the rate quotes based on the agency profitability rules. Further, the agency profitability rules may update when volume objectives are met. For example, the agency may qualify for discounted available fares with American Airlines but only when the agency sells a given dollar amount of American Airlines fare sales. Based on the agency profitability rules, the sort module 208 may sort rate quotes for flights on American Airlines higher than rate quotes from other airlines until the volume objective is met.

The client preferences database 210 and the agency profitability rules database 212 are any data structures configured to store and provide client preferences and agency profitability rules, respectively. In various embodiments, the communication interface module 200 provides an interface for an employee of the travel agency to create, remove, or modify the client preferences within the client preferences database 210 and/or the agency profitability rules within the agency profitability rules database 212.

It should be noted that the travel agency device 104 as depicted in FIG. 2 is exemplary. Alternative embodiments may comprise fewer modules performing the same or equivalent functions and still be within the scope of embodiments of the present invention. Further, the modules described in FIG. 2 may be hardware, software, or a combination of hardware and software.

The above-described functions and/or modules can be comprised of executable instructions that are stored on storage media. Storage media is any memory storage configured to store executable code and/or data. Some examples of the storage media include, but are not limited to, flash drives, hard drives, optical drives, compact disks (CDs), DVDs, and/or magnetic tape. In various embodiments, the travel agency device 104 includes the storage media.

The executable instructions can be retrieved and executed by a processor (e.g., a processor within the travel agency device 104). Some examples of executable instructions are software, program code, and firmware. Some examples of storage media are memory devices, tape, disks, integrated circuits, and servers. The executable instructions are operational when executed by the processor to direct the processor to operate in accord with the invention. Those skilled in the art are familiar with executable instructions, processor(s), and storage media.

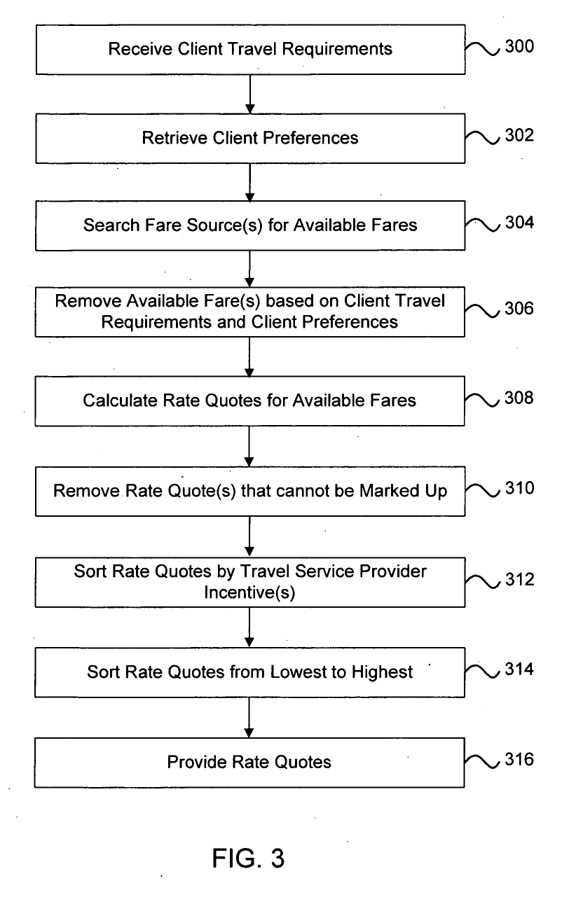

FIG. 3 is a flow chart of a method for generating rate quotes for travel services according to various embodiments. In step 300, the communication interface module 200 of the travel agency device 104 receives the client travel requirements either directly or from the agent device 102. In one example, an agent communicates with a client and inputs the client's travel requirements into the agent device 102 which, in turn, communicates them to the travel agency device 104.

In step 302, the search module 202 retrieves client preferences from the client preferences database 210. The client preferences, for example, specify that the client may only travel nonstop, any tickets purchased must be refundable, and that the client must travel on a specific airline.

The search module 202 then searches one or more fare sources for available fares, in step 304, for travel services that meet the client travel requirements (e.g., fare sources that provide available fares for travel services as specified by the client travel requirements) and the client preferences (e.g., fare sources that provide flights that are nonstop, refundable, and on a specific airline).

For example, the client travel requirements indicate a first class flight from city A to city B on a certain date. The search module 202 modifies the search based on the client preferences for the corporate client. In this example, the client preferences limit all air travel to United Airlines. However, the client preferences further limit the airline to American Airlines when traveling from select cities, including from city A to city B. The client preferences further specify that all travel be economy class or lower. However, the client preferences make an exception for a select number of employees (e.g., the CEO of the company). As a result, the search module 202 searches fare sources that can provide fares for travel services based on the client travel requirements and any overriding client preferences.

In some embodiments, the search module 202 may search a subset of the available fare sources. For example, the search module 202 may search only the GDS server 110 and not the service provider direct connect server 106 or the service provider web server 106 because the latter two fare sources do not provide fares for travel services that meet the client travel requirements and/or the client preferences.

In step 306, the filter module 204 removes available fares for travel services based on the client travel requirements and the client preferences. In various embodiments, the filter module 204 removes available fares, found as a result of the search, that do not meet the specifications of the client travel requirements and/or the client preferences.

In step 308, the rate quote calculator 206 calculates rate quotes for available fares for travel services. In various embodiments, the rate quote calculator 206 applies a fixed mark-up to the available fares that were not removed in step 306. In an example, the travel agency device 104 applies a set percentage (e.g., 10%) mark-up above an available fare. In another example, the travel agency device 104 adds a mark-up to the fare by subtracting a set percentage from a published fare. Those skilled in the art will appreciate that there may be many ways in which a mark-up may be applied to an available fare to calculate a rate quote.

The rate quote calculator 206, in step 310, removes rate quotes that cannot be marked-up or are otherwise unprofitable. In some embodiments, the rate quote calculator 206 removes rate quotes based on the agency profitability rules. For example, the travel rate quote calculator 206 may determine that the appropriate mark-up based on the agency profitability rules is a fixed rate for an available rate for one carrier and a percentage of the available fare for a second carrier. In another example, the travel agency device 104 reviews basis codes associated with the available fares to determine mark-ups. If a resulting calculated rate quote is above a published fare (or above a predetermined threshold), then the fare may be removed. Those skilled in the art will appreciate that there are many ways to identify a published fare and evaluate whether a rate quote should be removed.

It should be noted that although some examples contemplate removing one or more rate quotes after a comparison to a published fare, there may be many ways to remove a rate quote that is determined to be undesirable. In one example, one or more rate quotes may be analyzed (e.g., based on the market for travel services) to determine if the rate quotes are competitive. If one or more rate quotes are determined to be either non-competitive or otherwise unsellable, then the rate quote(s) may be removed.

In step 312, the sort module 208 sorts the rate quotes by travel service provider incentive. In various embodiments, the sort module 208 groups the rate quotes by travel service provider (e.g., airline) and then orders the groups based on the desired incentive to the agency. For example, the groups may be ordered based on highest override to the agency or highest discounts to the agency. The sort module 208 may also sort the rate quote groups based on volume incentives. For example, a certain volume of fare sales may be necessary to trigger a volume discount, override, or other incentive. In other embodiments, the sort module 208 may sort the groups based on the advantages and/or opportunity costs of various types of incentives offered by each group. Those skilled in the art will appreciate that the sort module 208 may sort the groups of rate quotes based on many different methodologies.

Further, the rate quotes can be divided into groups based on any criteria and not only by travel service provider. For example, the rate quotes may be grouped by date of flight, quality of accommodations offered, holidays, special events, or any combination of these. Those skilled in the art will appreciate that the sort module 208 may group the rate quotes on based on any criteria or combination of criteria.

In step 314, the sort module 208 sorts the rate quotes within each group. In some embodiments, the sort module 208 may sort the rate quotes within each group from lowest fare to highest fare. In some embodiments, the sort module 208 may sort the rate quotes within each group from highest mark-up to lowest. In various embodiments, the sort module 208 may sort the rate quotes within each group based on profitability of the rate quote to the agency, the impact of the sale of rate quotes towards achieving volume incentives, and/or the price of the rate quote to the client. Those skilled in the art will appreciate that the sort module 208 may sort the rate quote in many ways based on any criteria or combination of criteria.

Although FIG. 3 contemplates sorting the rate quotes first by travel service provider incentive and then sorting the rate quotes within those groupings, those skilled in the art will appreciate that the rate quotes may be sorted in any number of ways. For example, in some embodiments, the rate quotes may only be sorted by travel service provider incentive. In other embodiments, the rate quotes may be sorted from lowest price to highest price without sorting by travel service provider incentives.

In step 316, the communication interface module 200 provides the sorted rate quotes to the agent or travel service professional. In other embodiments, the rate quotes may be provided directly to the client. In one example, the sort module 208 sorts the rate quotes and any information regarding travel services associated with the rate quote within a table or other graphical structure (e.g., a formatted web page) that will help the agent or traveler understand the rate quote and/or the travel services associated with the rate quote. The communication interface module 200 then provides the table or other graphical structure to the agent.

The embodiments discussed herein are illustrative of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A method for generating rate quotes for travel services, the method comprising:
receiving client travel requirements;
searching one or more fare sources for a plurality of available fares based on the client travel requirements;
calculating a plurality of rate quotes based on the plurality of available fares;
removing a rate quote, from the plurality of rate quotes, that is not profitable based on agency profitability rules;
sorting the remaining plurality of rate quotes; and
providing the sorted remaining plurality of rate quotes.

2. The method of claim 1, wherein searching one or more fare sources for a plurality of available fares based on the client travel requirements further comprises searching the one or more fare sources for a plurality of available fares based on client preferences.

3. The method of claim 1, wherein the one or more fare sources include a global distribution system (GDS), a web server, a service provider server, and a travel agency device with locally stored fare data.

4. The method of claim 1 wherein calculating a plurality of rate quotes based on the plurality of available fares comprises determining a mark-up to apply to the plurality of available fares based on the agency profitability rules.

5. The method of claim 1, wherein removing a rate quote, from the plurality of rate quotes, that is not profitable based on agency profitability rules comprises removing a rate quote that is above a published fare.

6. The method of claim 1, wherein calculating the plurality of rate quotes based on the plurality of available fares comprises adding a mark-up to at least one of the plurality of available fares.

7. The method of claim 1, wherein at least one rate quote of the plurality of rate quotes is a fixed value greater than at least one of the plurality of available fares.

8. The method of claim 1, wherein at least one rate quote of the plurality of rate quotes is a fixed value less than a published fare associated with at least one of the plurality of available fares.

9. The method of claim 1, wherein at least one rate quote of the plurality of rate quotes is less than a published fare associated with at least one of the plurality of available fares.

10. The method of claim 1, wherein sorting the plurality of rate quotes is based on agency profitability rules.

11. The method of claim 11, wherein agency profitability rules are based on agency incentives.

12. A system for generating rate quotes for travel services, the system comprising:
a search module configured to search one or more fare sources for a plurality of available fares based on client travel requirements;
a rate quote module configured to calculate a plurality of rate quotes based on the plurality of available fares and remove a rate quote, from the plurality of rate quotes, based on agency profitability rules;
a sort module configured to sort the plurality of rate quotes; and
a communication interface module configured to receive the client travel requirements and provide the plurality of rate quotes.

13. The system of claim 12, wherein the search module configured to search one or more fare sources for a plurality of available fares based on client travel requirements is further configured to search one or more fare sources for a plurality of available fares based on client preferences.

14. The system of claim 12, wherein the one or more fare sources include a global distribution system (GDS), a web server, a service provider server, and a travel agency device with locally stored fare data.

15. The system of claim 12, wherein the rate quote module configured to calculate the plurality of rate quotes based on the plurality of available fares comprises the rate quote module configured to determine a mark-up to apply to each of the plurality of available fares based on the agency profitability rules.

16. The system of claim 12, wherein the rate quote module configured to calculate the plurality of rate quotes based on the plurality of available fares and remove a rate quote, from the plurality of rate quotes, based on agency profitability rules comprises the rate quote module configured to add a mark-up to one of the plurality of available fares, the mark-up being based on the agency profitability rules, and removing the rate quote if above a published fare.

17. The system of claim 12, wherein the rate quote module configured to calculate a plurality of rate quotes comprises adding a mark-up to at least one of the plurality of available fares.

18. The system of claim 12, wherein at least one rate quote of the plurality of rate quotes is a fixed value greater than at least one of the plurality of available fares.

19. The system of claim 12, wherein at least one rate quote of the plurality of rate quotes is a fixed value less than a published fare associated with at least one of the plurality of available fares.

20. The system of claim 12, wherein at least one rate quote of the plurality of rate quotes is less than a published fare associated with at least one available fare.

21. The system of claim 12, wherein the sort module configured to sort the plurality of rate quotes is configured to sort the plurality of rate quotes based on agency profitability rules.

22. The system of claim 12, wherein the agency profitability rules are based on agency incentives.

23. A computer readable storage medium having embodied thereon executable computing instructions for performing a method for generating rate quotes for travel services, the method comprising:
receiving client travel requirements;
searching one or more fare sources for a plurality of available fares based on the client travel requirements;
calculating a plurality of rate quotes based on the plurality of available fares;
removing a rate quote, from the plurality of rate quotes, that is not profitable based on agency profitability rules;
sorting the remaining plurality of rate quotes; and
providing the sorted remaining plurality of rate quotes.

24. A method for generating rate quotes for travel services, the method comprising:
receiving client travel requirements;
querying one or more fare sources based on the client travel requirements;
receiving a plurality of available fares from the one or more fare sources;
calculating a plurality of rate quotes based on the plurality of available fares;
identifying one or more rate quotes, from the plurality of rate quotes, that are profitable based on agency profitability rules;
sorting the one or more identified rate quotes; and
providing the sorted one or more identified rate quotes.
